(19) United States
(12) Patent Application Publication
(10) Pub. No.: US 2016/0066003 A1
(43) Pub. Date: Mar. 3, 2016

(54) VIRAL TUNING METHOD

(71) Applicant: THOMSON LICENSING, Issy les Moulineaux (FR)

(72) Inventors: Michael Evan FOOTE, Carmel, IN (US); Benjamin Thomas VONDERSAAR, Indianapolis, IN (US)

(73) Assignee: Thomson Licensing

(21) Appl. No.: 14/784,748

(22) PCT Filed: Jun. 4, 2013
(86) PCT No.: PCT/US2013/044047

§ 371 Date: Oct. 15, 2015

(51) Int. Cl. H04N 21/25; H04N 21/45; H04N 21/488; H04N 21/466; H04N 21/4788

(52) U.S. Cl. CPC H04N 21/252; H04N 21/4667; H04N 21/4788; H04N 21/4882; H04N 21/4668; H04N 21/4532

(57) ABSTRACT

A method of scoring and arranging events related to entertainment content for a user in a viral tuning system is disclosed. The method comprising checking for a new event associated with media content; determining whether the new event is selected; applying a new score to the new event; associating the new event with one or more sub-events, each sub-event having a prior score and associated with the media content associated with the new event; adding the prior scores of the sub-events to the new score of the new event, resulting in a total score; adding an interest value to the total score, resulting in a new total score, the interest value being based on whether the new event is selected; and associating the new total score with the new event.

### BACKGROUND

As the technology behind social media and entertainment content distribution advances, so does the interaction between these two areas of technology. An example where these two areas interact is a process called viral tuning, where one's television viewing options are organized and recommended based on the choices made by one's social media connections. In essence, a viral tuning system receives event notifications of when friends choose to watch a particular program, and subsequently decides whether to display the event based on user-defined filters for events and senders of events. Currently, viral tuning can be implemented using a standard set-top box or an independent apparatus that is connected to a television. An example of a viral tuning system can be seen in International Patent Application Serial No. PCT/US2011/064540.

However, the current state of viral tuning is simplistic. The filters provided in current viral tuning systems are binary in that only they decide whether or not to display an event notification to a user. As a result, event notifications that make it through the viral tuning system's filter are displayed to the user based on the time at which they arrived, not based on their likely value to the user. To date, no known scheme exists for organizing and prioritizing such notifications based on the user's level of interest.

### SUMMARY

In view of the foregoing, a method of scoring and arranging events related to entertainment content for a user in a viral tuning system is disclosed. The method is performed by a user's electronic device, which includes a memory and a processor, and is coupled with a display screen. The method comprises checking for a new event notification, the new event notification being associated with a new event, the new event being associated with an entertainment program; determining whether the user selected the new event for enjoyment; applying a new score to the new event; associating the new event with at least one sub-event, the at least one sub-event having at least one corresponding old score applied thereto and being associated with the same entertainment program associated with the new event; adding the at least one corresponding old score of the at least one sub-event to the new score of the new event, resulting in a total score; adding an interest value to the total score, resulting in a new total score, the interest value being based on whether the user selected the new event for enjoyment; and associating the new total score with the new event.

### BRIEF DESCRIPTION OF THE DRAWINGS

For a more complete understanding of the present invention, reference is made to the following detailed description of an embodiment considered in conjunction with the accompanying drawings, in which:

FIG. 1 is a block diagram of a prior art viral tuning system for arranging and filtering delivered media content according to a user's preferences;

FIG. 2 is a flow chart illustrating an exemplary process for scoring and arranging events in accordance with an embodiment of the present invention;

FIG. 3 is a flow chart illustrating an exemplary new event routine for use in the process shown in FIG. 2;

FIG. 4 is a flow chart illustrating an exemplary input update process for use in the process shown in FIG. 2;

FIG. 5 is a flow chart illustrating an exemplary score calculation process for use in the process shown in FIG. 2;

FIG. 6 is a flow chart illustrating an exemplary resource management process for a viral tuning system in accordance with an embodiment of the present invention;

FIG. 7 is a flow chart illustrating an exemplary floating tuner control process for use in the process shown in FIG. 6;

FIG. 8 is a flow chart illustrating an exemplary floating/idle recorder control process for use in the process shown in FIG. 6; and

FIG. 9 is a flow chart illustrating an exemplary orphaned/ghost file management process for use in the process shown in FIG. 6.

### DETAILED DESCRIPTION

The present disclosure generally relates to a viral tuning system and method where incoming and existing events are scored and sorted in a list based on certain characteristics of the events and the value those characteristics have with respect to a user's preferences and desires. Events can include a friend switching to or from a particular television channel, a friend choosing to record a particular media content, and other such activities related to a friend's enjoyment, of media content. The configured viral tuning system scores such events by determining a value for a particular event, where such value can be based on the number of friends associated with an event, the identity of the friends associated with the event, the program type associated with the event, the content provider associated with a particular program, the time-sensitivity of the program, and the user's media content watching preferences, among others. After scoring such events, the configured viral tuning system can sort the events based on the priority of their scores and present the sorted list of events, or a relevant portion thereof, to the user who may decide to switch to a particular program associated with one of the events presented. This system reduces the decision-making time a user must take in deciding whether to switch to different media content and to what media content he/she would like to switch.

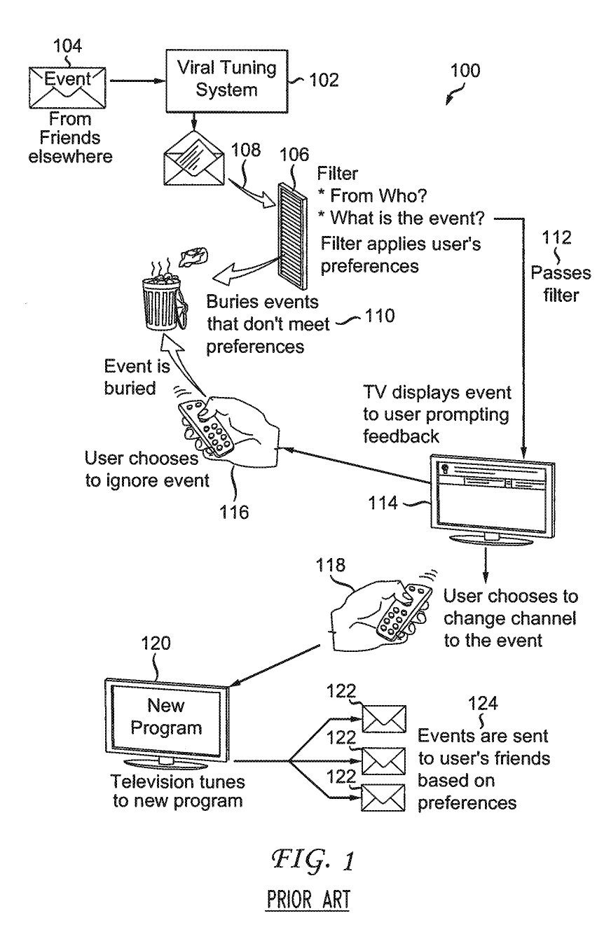

Turning now to FIG. 1, it illustrates a prior art viral tuning process 100 similar to that disclosed in International Patent Application Serial No. PCT/US2011/064540. The viral tuning process 100 features a viral tuning system 102 that includes at least a memory for storing a list of events and a receiver for receiving new events from outside sources, such as friends from the user. The viral tuning system 102 also includes a processor for executing processes with respect to the list of events stored on the memory, as well as executing processes with respect to events that are received by the receiver of the viral tuning system 102.

As seen in FIG. 1, the viral tuning system 102 receives an event 104 from an outside source, whereupon the viral tuning system 102 sends the event 104 through a filter 106 that determines whether the event 104 would be deemed relevant to the user's interests (step 108). If the event 104 gets caught in the filter 106 (e.g., the event 104 fails to meet the user's criterion for relevancy as defined in the filter 106), then the system buries (e.g., tags it as undesirable, removes it from a list, segregates it, sends it to a low priority list, deletes it, stops its progression through the process, etc.) the event (step 110) as being not relevant, to the user's interests.

If, however, the event 104 passes through the filter 106 (step 112), the event 104 is deemed relevant and is then communicated to the user's television 114, which displays the event 104 to the user and prompts the user for feedback. If the user chooses to ignore the event 104 (step 116), the event 104 gets buried (step 108) as being not relevant to the user's interests. If, however, the user chooses to select the program related to the event 104 (step 118), the system 102 changes the channel to the selected event 104 (step 120) and subsequently transmits this new event 122 to the friends of the user (step 124). This process 100 begins anew for each new event that the viral tuning system 102 receives.

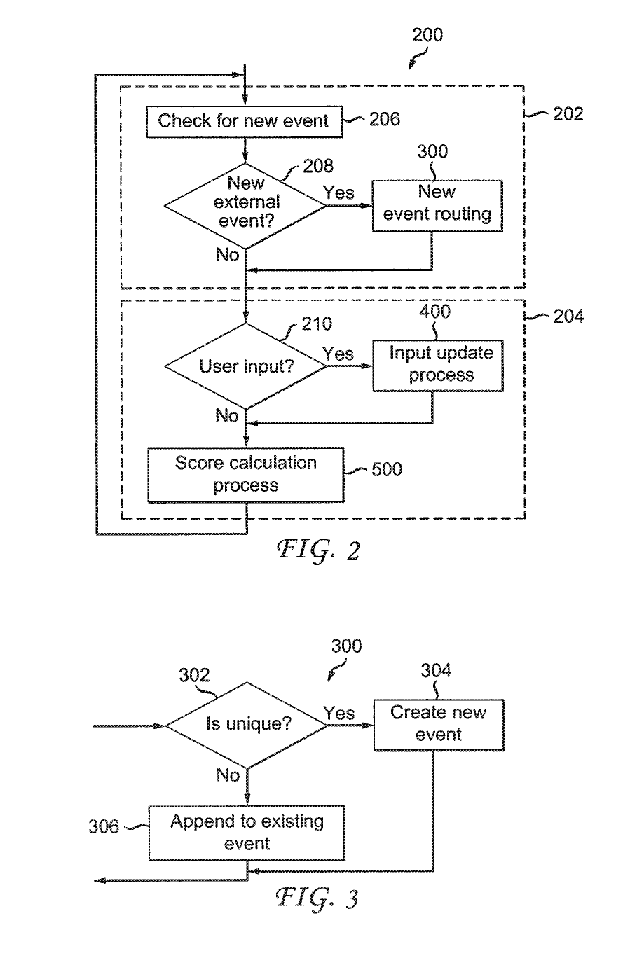

Turning now to FIG. 2, a flow chart of a tuning process 200 for scoring events in a viral tuning system in accordance with an embodiment of the present invention is shown. The tuning process 200 generally includes two stages: a new event stage 202; and a updating stage 204. The new event stage 202 begins by checking for whether a new event notification has been received (step 206). Upon learning that a new event notification has been received, the viral tuning system determines whether the event associated with the notification is a new external event (e.g., an event associated with a friend's activity, rather than the user's activity, that has not been previously received, etc.) (step 208). If the viral tuning system determines that the event associated with the notification is indeed a new event, the viral tuning system then executes a new event routine 300, which is illustrated in FIG. 3 and discussed in greater detail further below.

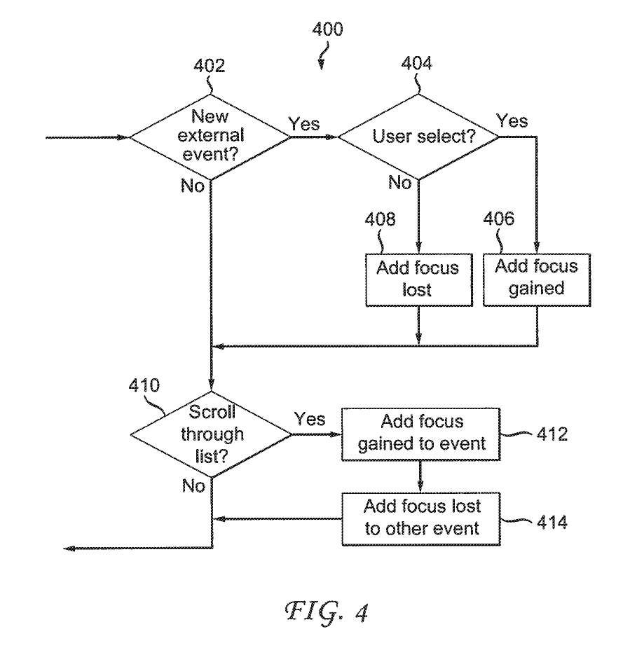

After the new event routine, or if the notification did not involve a new external event, the viral tuning system proceeds to the updating stage 204 by determining whether the user provided any input with respect to the new event (step 210). Such input can include, but is not limited to, an indication that the user selected a program and/or media content associated with the event for watching, an indication that a user has chosen to record a program and/or media content, or an indication that the user has viewed and passed over the event in scrolling through a list of events located in the system's memory. If the viral tuning system determines that the user provided input with respect to the new event, the viral tuning system executes an input update process 400 that updates the user's list of programs and/or media content and events with the input provided by the user. The input, update process 400 is illustrated in FIG. 4 and discussed in greater detail further below.

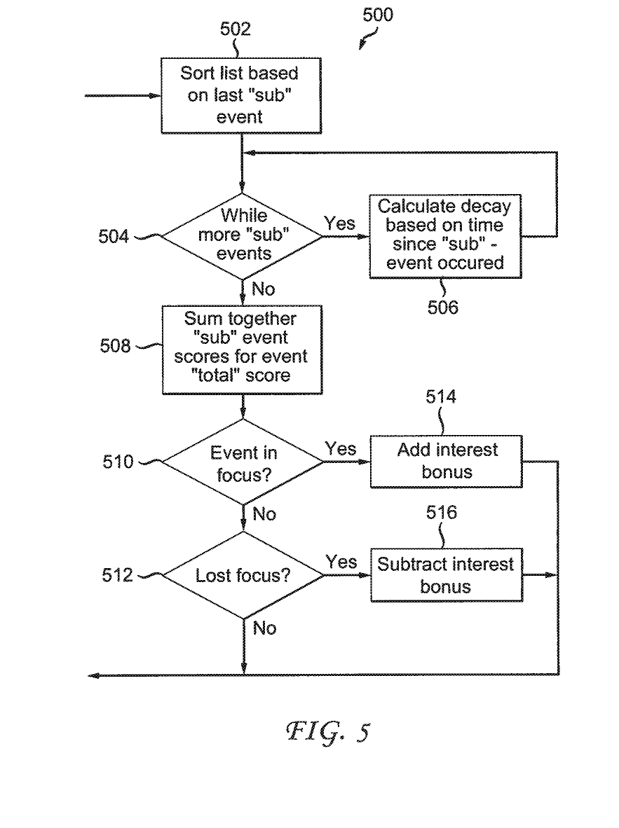

After the user's list of programs, media content and/or events has been updated with the user's input, or in the event that the user provided no input with respect to the new event, the viral tuning system executes a score calculation process 500 that updates the user's list of programs, media content and/or events with the information corresponding to the new event and adjusts the scores of the programs, media content and events listed therein accordingly. The score calculation process 500 is illustrated in FIG. 5 and discussed in greater detail further below. After completing the score calculation process 500, the tuning process 200 starts anew at the new event stage 202.

FIG. 3 illustrates the new event routine 300 of the new event stage 202 discussed above. After the tuning process 200 has decided that the new event notification involves a new external event (step 206; see FIG. 2), the viral tuning system determines whether the event associated with the new event notification is unique (step 302) by checking the information associated with the new event notification against the viral tuning system's list of events located in its memory. An event can be unique when the underlying program associated with the event notification is not stored within the viral tuning system's memory, or if the underlying program and/or media content is already stored within the system's memory but the event, occurred a predetermined time after a previous event associated with the program and/or media content occurred. In such circumstances, the viral tuning system creates a new event including associations with the friend and the underlying program (step 304), stores the new event in the viral tuning system's memory, and then proceeds to the updating stage 204 (see FIG. 2). If, however, the event associated with the new event notification is not unique, the underlying event is treated as a sub-event (e.g., an event involving the same program and/or media content as one already in the system's memory but having different time and friend association information), the viral tuning system adds the information associated with the new event notification to the existing event in the viral tuning system's memory. The system then proceeds to the updating stage 204 discussed above.

FIG. 4 illustrates an input update process 400 in accordance with an embodiment of the present invention that may be implemented after the system had determined that the new event notification includes user input (step 206; see FIG. 2). The input update process 400 begins by determining whether the new event notification involves a new external event (step 402). This determination should match the similar determination made during the new event stage 202 shown in FIG. 2. If the viral tuning system determines that the new event is a new external event, the system next determines whether the user of the viral tuning system selected the program and/or media content associated with the new event for watching (step 404). If the user did select the new event's underlying program and/or media content for watching, the system adds a “focus gained” marker to the new event (step 406) indicating the user's interest in the new event. If, however, the user does not select the new event's underlying program for watching, the system adds a “focus lost” marker to the new event (408) indicating the user's lack of interest in the new event.

After adding a “focus gained” or “focus lost” marker to the new event, or in the case where the new event notification does not involve a new external event, the system proceeds to determine whether the user selected the new event by scrolling through a list of events stored on the viral tuning system's memory in which the new event was located (step 410). If so, the system adds a “focus gained” marker to the new event selected for viewing (step 412). In addition, for every event in the list of events that the user passed over (e.g., highlighting an event for inspection and then subsequently un-highlighting it as the user scrolls through the list of events), the system adds a “focus lost” marker thereto (step 414). Thereafter, the system proceeds to the score calculation process 500 identified in FIG. 2.

FIG. 5 illustrates a score calculation process 500 in accordance with an embodiment of the present invention that can be implemented following the input update process 400 discussed above. The score calculation process 500 begins by sorting the list of events stored in the viral tuning system's memory (step 502), with sub-events of a particular event being shown together. A “sub-event” is an event that is not unique and is associated with one or more other events listed in the viral tuning system's memory (e.g., the sub-event shares the same entertainment program and/or media content and is in close time proximity with other listed events). In the case where a number of sub-events are listed in the list of events, the sub-events are arranged chronologically.

Thereafter, the viral tuning system determines whether the new event is associated with any sub-events (step 504). If the new event is associated with other sub-events, the system proceeds to calculate a decay value for each sub-event based on the time elapsed since the sub-event occurred (step 506). This decay value represents the level of interest the user has in the event, as the longer the length of time elapsed since the event occurred, the less likely interest the user has in viewing the underlying program. Once the decay value for each sub-event has been calculated, the decay values are applied to the scores associated with the sub-events, and the scores of the sub-events are then summed for an event total score (step 508). However, if the new event is not associated with any sub-events (e.g., the new event is unique), then the new event is given a base score that functions as a “total score,” since there were no sub-event scores to total in creating a total score for the new event.

After calculating the total score of a new event based on sub-events, the viral tuning system determines whether the new event includes a “focus gained” marker (step 510) and/or a “focus lost” marker (step 512). If the new event includes a “focus gained” marker, the viral tuning system adds an “interest bonus” to the score of the new event (step 514) based on the user expressing interest in the underlying program. If, however, the new event does not include a “focus gained” marker but includes a “focus lost” marker, the viral tuning system subtracts the “interest bonus” from the score of the new event (step 516) based on the user expressing a lack of interest in the underlying program. In the case where the new event includes no marker for “focus gained” or “focus lost,” the score of the new event remains unchanged. The viral tuning system then associates this score with the new event and writes the score into the viral tuning system's memory.

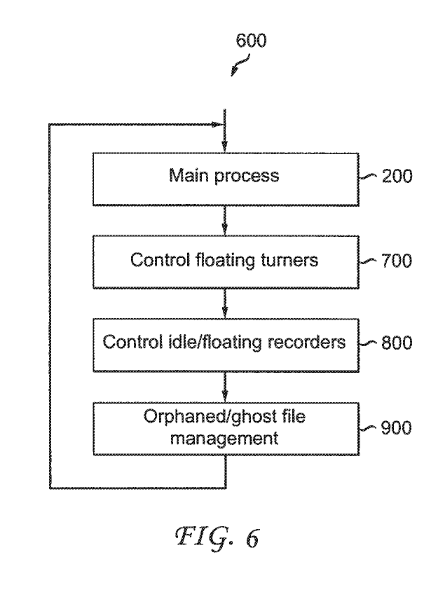

FIG. 6 illustrates a resource management method 600 in a viral tuning system in accordance with an embodiment of the present invention. The resource management method 600 uses the scores generated by the tuning process 200 discussed above to control the activities of additional tuners and content recorders associated with the viral tuning system, as well as optimally manage the available storage resources in the viral tuning system's memory such that they keep the events and programs and/or media content of interest to the user while discarding those that fail to gamer such interest. Accordingly, the resource management method 600 includes a floating tuner control process 700, a floating content recorder control process 800, and an orphaned/ghost file management process 900, each of which is discussed in greater detail further below. One purpose of the floating tuner control process 700 and the floating content recorder control process 800 is to ensure that the highest scored events are being tuned and recorded to minimize channel switching time for the user and maximize the user's enjoyment of available entertainment.

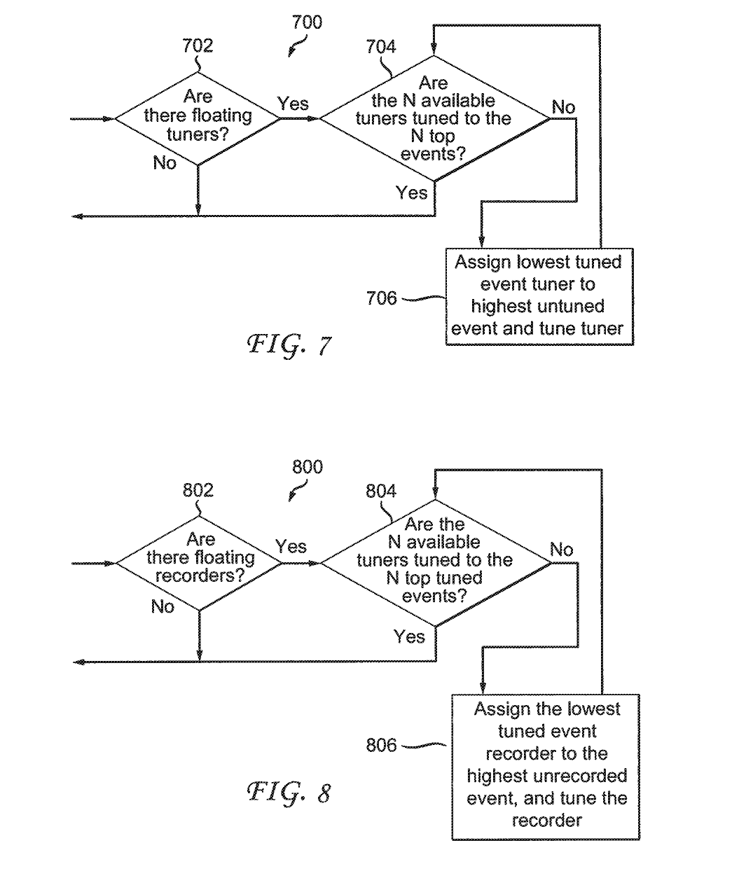

FIG. 7 illustrates a floating tuner control process 700, and FIG. 8 illustrates a floating content recorder control process 800. As used herein, the term “floating” refers to apparatuses within the viral tuning system that are not being actively controlled by the user and is instead operating free of direction from the user. For instance, in a viral tuning system having multiple tuners which can be tuned to receiving separate entertainment programs, a floating tuner is a tuner that is tuned to a particular channel in the absence of any direct control from the user (e.g., the user did not direct or schedule the tuner to tune to its current channel). Likewise, in a viral tuning system having one or more content recorders, such as a digital video recorder (“DVR”), capable of recording and storing entertainment content onto a memory for replay at a later time, a floating recorder is a recorder that is recording a program in the absence of direct instruction from the user.

With reference to FIG. 7, the floating tuner control process 700 begins by checking for whether any tuners in the viral tuning system are floating (step 702). If there are no floating tuners, the system proceeds to the floating content recorder control process 800. However, if the check reveals one or more floating tuners, the system then checks whether the N_{T} available floating tuners are tuned to the N_{T} top events listed (e.g., the N_{T} events having the highest scores as determined by the score calculation process 400 of the viral tuning process 200) in the user's list of events (step 704). If not, the tuner of the N_{T} floating tuners that is tuned to the lowest scored event is then assigned to tune to the highest scored untuned event (step 706). Steps 704 and 706 are then repeated in succession until all N_{T} floating tuners are assigned to tune to the events having the highest score, at which point the system proceeds to the floating content recorder control process 800.

With reference to FIG. 8, the floating content recorder control process 800 begins by checking for whether any recorders in the viral tuning system are floating or idle (step 802). If there are no floating or idle recorders, the system proceeds to the orphaned/ghost file management process 900. However, if the check reveals one or more floating or idle recorders, the system then checks whether the N_{R} available floating/idle recorders are tuned to the N_{R} top tuned events listed in the user's list of events and recording the programs associated therewith (step 804). If not, the recorder of the N_{R} floating/idle recorders that is either idle or tuned to the lowest scored tuned event is then assigned to tune to and record the highest scored unrecorded tuned event (step 806). Steps 804 and 806 are then repeated in succession until all N_{R} floating/idle recorders are assigned to tune to and record the tuned events having the highest score, at which point the system proceeds to the orphaned/ghost file management process 900.

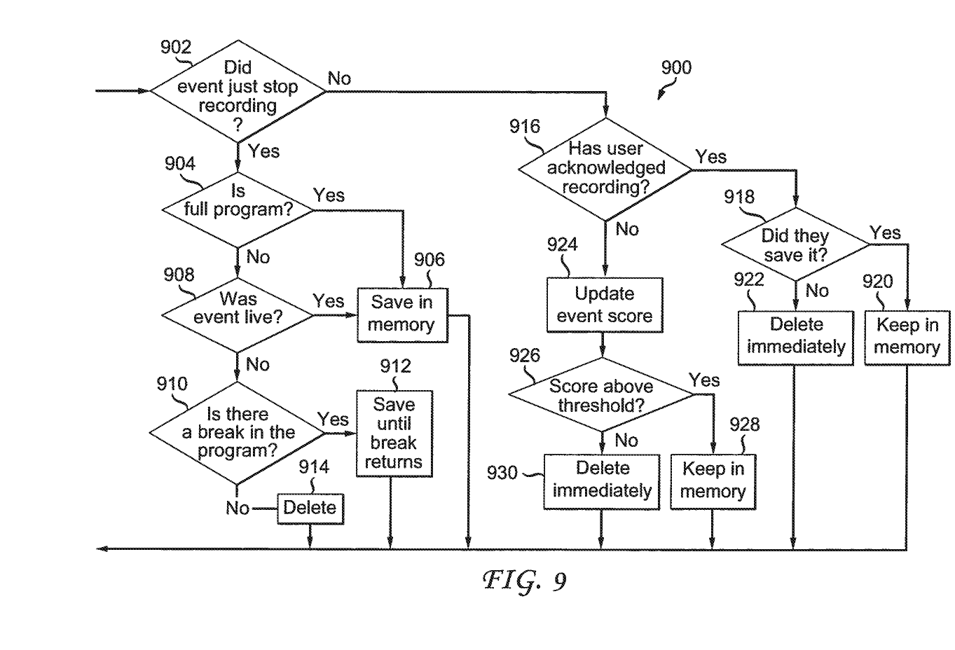

FIG. 9 illustrates an orphaned/ghost file management process 900 in accordance with an embodiment of the present invention. The orphaned/ghost file management process 900 is configured to allow the limited storage and tuning resources available in the viral tuning system to be utilized in a manner that maximizes the system's utility for the user. The orphaned/ghost file management process 900 begins by checking for whether an event has recently stopped recording (step 902). If so, the system checks for whether the recorded event included a fully recorded program (step 904). If so, the system saves the recorded program in the system's memory (step 906). If the underlying program was not fully recorded, the system then checks for whether the recorded event was a live event (step 908). If so, the system likewise saves the recorded program in the system's memory (step 906).

However, if the recorded event was neither live nor fully recorded, the system then checks for whether there was a break in the recordation of the underlying program (step 910). If there was such a break, the system then saves the partial event until the break returns (step 912). If there was no such break, then the system deletes the recorded program (step 914). The reasoning behind this portion of the process is that if any of the three previously mentioned conditions (e.g., steps 904, 908, and 910) are met, the stopped event recording is likely to be of interest to the user. However, if none of the aforementioned conditions are met, the stopped event recording likely has negligible value to the user and the resources necessary to maintain the stopped event recording would likely be more useful in recording a higher-priority event.

Referring back to step 902 of FIG. 9, if the check determines that the event did not recently stop recording, the system checks for whether the user acknowledged the event recording (step 916). If so, the system then checks whether the user saved the acknowledged recording (step 918). If so, the system keeps the acknowledged recording in memory (step 920). If not, the system then deletes the acknowledged recording (step 922) as being no longer relevant to the user's interests.

If, however, the user did not acknowledge the event recording, the system updates the score for the recorded event (step 924). The updating of the score for the recorded event can be executed by any number of processes, including the score calculation process 500 illustrated in FIG. 5. The system then checks for whether the updated score of the recorded event is above a predetermined threshold (step 926). The predetermined threshold in step 926 can be based on the amount of resources currently available in the viral tuning system's memory, which can change over time, and the amount of resources necessary to record a future event set to be recorded by the viral tuning system. The predetermined threshold of step 926 can also be a fixed threshold set as a default or as directed by the user. In the event that the score of the unacknowledged event recording remains above the predetermined threshold, the system maintains the event recording in the viral tuning system's memory (928). If not, the system deletes the unacknowledged event recording from the system's memory (step 930) as being not relevant enough to maintain in favor of recording more highly-scored events.

The various embodiments disclosed herein can be implemented as hardware, firmware, software, or any combination thereof. Examples of such devices include those disclosed in International Patent Application Serial No. PCT/US2011/064540, the disclosure of which is incorporated by reference herein in its entirety. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

1. A method of scoring and arranging events related to media content in a viral tuning system, the method performed by an electronic device, the electronic device including a memory and a processor and coupled with a display screen, the method comprising:
checking for a new event notification, the new event notification associated with a new event, the new event associated with media content;
determining whether a new event is selected;
applying a new score to the new event;
associating the new event with at least one sub-event, the at least one sub-event having at least one corresponding prior score applied and associated with the same media content associated with the new event;
adding the at least one corresponding prior score of the at least one sub-event to the new score of the new event, resulting in a total score;
adding an interest value to the total score, resulting in a new total score, the interest value based on whether the user selected the new event; and
associating the new total score with the new event.

2. The method of claim 1, wherein the interest value is a positive value when the new event is selected.

3. The method of claim 1, wherein the interest value is a negative value when the new event is not selected.

4. The method of claim 1, wherein the at least one corresponding prior score of the at least one sub-event is decreased based on when the at least one sub-event is received by the viral tuning system.

5. The method of claim 1, wherein the determining whether the new event is selected includes checking for whether a list of a plurality of events was scrolled through before selecting a new event, each of the plurality of events having a score associated with it.

6. The method of claim 5, wherein a negative second interest value is added to the score of each event of the plurality of events that was scrolled past when scrolling through the list of the plurality of events to select a new event.

7. The method of claim 1, wherein the viral tuning system further includes a plurality of tuners, the memory includes a plurality of stored events, the plurality of events having associated scores, and the method further comprising:
determining whether the plurality of tuners includes one or more floating tuners;
determining whether the one or more floating tuners are tuned to a corresponding number of a set of events from the plurality of events, the set of events having scores higher than the scores of the plurality of events remaining; and
when one of the one or more floating tuners is tuned to one of the plurality of events remaining, assigning the one of the one or more floating tuners to tune to one of the set of events.

8. The method of claim 7, wherein the viral tuning system further includes a plurality of content recorders, the plurality of events including one or more tuned events to which the one or more floating tuners are tuned, respectively, and the method further comprises:
determining whether the plurality of content recorders includes one or more floating or idle content recorders;
determining whether the one or more floating or idle content recorders are tuned to record a corresponding number of a set of tuned events, the set of tuned events having scores higher than the scores of the plurality of tuned events remaining; and
when one of the one or more floating or idle content recorders is tuned to record one of the plurality of tuned events remaining, assigning the one of the one or more floating or idle content recorders to tune to and record one of the set of tuned events.

9. The method of claim 8, further comprising:
checking whether one of the plurality of content recorders has finished recording an event;
checking whether the recorded event has been acknowledged;
when the recorded event has not been acknowledged, updating the score of the recorded event;
checking whether the score of the recorded event is higher than a predetermined threshold; and
when the score of the recorded event is lower than the predetermined threshold, deleting the recorded event.

10. An electronic device in a viral tuning system for scoring and arranging events related to media content, the electronic device comprising:
a memory for storing a plurality of events, each of the plurality of events having a corresponding score and being associated with media content;
a receiver for receiving event notifications from at least one source; and
a processor configured to:
check the receiver for a new event notification, the new event notification associated with a new event, the new event associated with media content;
determine whether the new event is selected;
apply a new score to the new event;
check the memory for at least one sub-event from among the plurality of events, the at least one sub event having at least one corresponding prior score applied and associated with the media content associated with the new event;
associate the new event with the at least one sub-event;
add the at least one corresponding prior score of the at least one sub-event to the new score of the new event, resulting in a total score;
add an interest value to the total score, resulting in a new total score, the interest value based on whether the new event is selected;
associate the new total score with the new event; and
record the new event with the new total score in the memory.
